(19) United States
(12) Patent Application Publication
(10) Pub. No.: US 2026/0274042 A1
(43) Pub. Date: Sep. 17, 2026

(54) AIR OUTLET ASSEMBLY OF AIR CONDITIONER, MAIN BODY OF AIR CONDITIONER, AND VEHICLE

(71) Applicants: WUHU MATY AIR-CONDITIONING EQUIPMENT CO., LTD., Wuhu (CN); GD MIDEA AIR-CONDITIONING EQUIPMENT CO., LTD., Foshan (CN)

(72) Inventor: Yinyin ZHANG, Wuhu (CN)

(21) Appl. No.: 19/168,429

(22) PCT Filed: Sep. 15, 2023
(86) PCT No.: PCT/CN2023/118941

§ 371 Date: Sep. 24, 2025

(30) Foreign Application Priority Data
Apr. 7, 2023 (CN) 202310391203.7
Apr. 7, 2023 (CN) 202320812001.0

(51) Int. Cl. B60H 1/24

(52) U.S. Cl. CPC B60H 1/245

(57) ABSTRACT

An air outlet assembly includes a mounting member provided with a first connection member configured to be connected to a vehicle, an air outlet panel located below the mounting member and provided with a second connection member connected to the mounting member, an air inlet channel communicating the mounting member with the air outlet panel, and an air outlet channel spaced apart from the air inlet channel in a front-rear direction of the air outlet assembly and communicating the mounting member with the air outlet panel. One end of the air inlet channel has an air inlet formed at the air outlet panel, and one end of the air outlet channel has an air outlet formed at the air outlet panel.

The present application claims priority to Chinese Patent Application Nos. 202310391203.7 and 202320812001.0, both filed on Apr. 7, 2023, the entire contents of which are incorporated herein by reference.

### TECHNICAL FIELD

The present application relates to the technical field of air conditioners, in particular to an air outlet assembly of an air conditioner, a main body of an air conditioner, and a vehicle.

### BACKGROUND

A roof-mounted motorhome air conditioner supplies air to the interior of a vehicle after being mounted at the roof of the vehicle, indoor air outlet and air supply terminals need to be adapted to the whole machine to achieve excellent indoor mounting aesthetics and air supply comfort goals. In the related art, the air outlet panel of the air conditioner involves a cross-inlet and outlet design. The air outlet and air inlet of the air conditioner are located on the side of the air outlet panel. The large deflection of the air outlet path will cause large resistance to air flow and large air supply loss.

### SUMMARY

### Technical Problem

The main purpose of the present application is to provide an air outlet assembly of an air conditioner, a main body of an air conditioner, and a vehicle, aiming to solve the problem that the existing air conditioner mounted at a motorhome is subject to large resistance to air flow due to the large deflection of the air outlet path, resulting in large air supply losses.

### Technical Solution

To achieve the above purpose, the present application provides an air outlet assembly of an air conditioner, including:
a mounting member provided with a first connection member configured for connecting to the vehicle;
an air outlet panel located below the mounting member; the air outlet panel is provided with a second connection member, and the second connection member is connected to the mounting member;
an air inlet channel communicating the mounting member with the air outlet panel; an air inlet is formed at the air outlet panel at one end of the air inlet channel; and
an air outlet channel spaced apart from the air inlet channel in a front-rear direction of the air outlet assembly, and the air outlet channel communicating the mounting member with the air outlet panel; an air outlet is formed at the air outlet panel at one end of the air outlet channel.

In an embodiment, the mounting member includes a mounting panel, and the mounting panel is connected to the second connection member of the air outlet panel; and
an air inlet hole is formed at the mounting panel at the other end of the air inlet channel, and an air outlet hole is formed at the mounting panel at the other end of the air outlet channel.

In an embodiment, the mounting member further includes a first partition, and the first partition is provided at a side of the mounting panel away from the air outlet panel and between the air inlet hole and the air outlet hole, for separating the air inlet channel and the air outlet channel.

In an embodiment, a second partition is further provided between the mounting panel and the air outlet panel, and the second partition is provided between the air outlet and the air inlet to limit an intersection of an outlet airflow between the air outlet hole and the air outlet, and an inlet airflow between the air inlet hole and the air inlet.

In an embodiment, a mounting area for mounting electronic device is formed between the mounting panel and the air outlet panel.

In an embodiment, the air outlet is further provided with an air guide plate structure; the air guide plate structure includes an air guide plate, and the air guide plate is movably provided at the air outlet; the air guide plate has a first position covering the air outlet during a movable stroke;
when the air guide plate is located at the first position, at least a portion of the air guide plate is configured to cover a peripheral position of the air outlet; and
the second connection member is provided corresponding to an area on the air outlet panel capable of being covered by the air guide plate.

In an embodiment, the air outlet panel is provided with a sunken platform on a side away from the mounting member and around a periphery of the air inlet;
the sunken platform is provided with a protective net, a filter net and an air inlet grille stacked in sequence in a direction away from the air outlet panel;
the second connection member is correspondingly provided at the sunken platform; and
the air inlet grille is provided to cover the sunken platform.

In an embodiment, a matching member is provided at one of the sunken platform and the protective net, and a limitation member is provided at the other one of the sunken platform and the protective net; a limitation groove is formed at the limitation member, and the limitation groove is configured for the matching member to be embedded.

In an embodiment, the filter net is detachably mounted at a side of the air inlet grille close to the air outlet panel; and
a buckle groove is formed at one of the air inlet grille and the sunken platform, and a buckle holder is provided at the other one of the air inlet grille and the sunken platform; the buckle holder is buckled in the buckle groove accordingly.

In an embodiment, a limitation member is provided at the air outlet panel, and the limitation member is configured to limit the air outlet panel in a direction away from a main body of the air conditioner.

In an embodiment, the first connection member includes a screw provided at the mounting member; and/or
the second connection member includes a mounting hole opened at the air outlet panel.

The present application also provides a main body of an air conditioner, configured to be mounted at a top of a vehicle; the main body of the air conditioner includes a body, and the air outlet assembly is connected below the body.

The present application also provides a vehicle, including:
a vehicle body; a mounting channel is formed at the vehicle body; and
the main body of the air conditioner; the body of the main body of the air conditioner is at least partially connected to the mounting channel.

### BENEFICIAL EFFECT

In the technical solution of the present application, the mounting member and the air outlet panel are assembled on the vehicle to form the air inlet channel and the air outlet channel, and the air inlet channel and the air outlet channel are connected to the indoor environment of the vehicle through the air inlet and the air outlet respectively. Since the air inlet and the air outlet are both formed at the air outlet panel, the problem of large air path turns of the air inlet duct and the air outlet duct causing resistance to air flow and resulting in large air supply losses is greatly avoided.

### BRIEF DESCRIPTION OF THE DRAWINGS

In order to more clearly illustrate the technical solutions in the embodiments of the present application or the related art, the following will briefly introduce the drawings that need to be used in the description of the embodiments or the related art. Obviously, the accompanying drawings in the following description are only some embodiments of the present application, and those skilled in the art can also obtain other drawings according to the structures shown in these drawings without creative effort.

FIG. 1 is a schematic structural diagram of a front view of a main body of an air conditioner according to an embodiment of the present application.

FIG. 2 is a schematic partial cross-sectional structural diagram of the main body of the air conditioner according to an embodiment of the present application.

FIG. 3 is a schematic cross-sectional structural diagram of the main body of the air conditioner according to an embodiment of the present application.

FIG. 4 is a schematic diagram of an exploded structure of the main body of the air conditioner according to an embodiment of the present application.

FIG. 5 is a schematic diagram of an exploded structure of an air outlet assembly of the air conditioner according to an embodiment of the present application.

FIG. 6 is a schematic structural diagram of the front view of the mounting member in FIG. 5.

FIG. 7 is a schematic structural diagram of the front view of the air outlet panel in FIG. 5.

FIG. 8 is a schematic structural diagram of the air outlet panel in FIG. 5 from one viewing angle.

FIG. 9 is a schematic structural diagram of the assembly structure of the air outlet panel and the protective net in FIG. 5.

FIG. 10 is a schematic structural diagram of the front view of the air inlet grille in FIG. 5.

FIG. 11 is a schematic diagram of the mounting of the main body of the air conditioner according to an embodiment of the present application.

FIG. 12 is a schematic enlarged structural diagram of point A in FIG. 11.

Description of reference signs:

| Reference | | Reference | |
|---|---|---|---|
| sign | Name | sign | Name |
| 100 | air outlet assembly | 14 | second heat- |
| | | | insulation member |
| 11 | air outlet panel | 15 | mounting area |
| 2 | air inlet | 16 | air guide plate |
| | | | structure |
| 3 | air outlet | 161 | air guide plate |
| 4 | limitation member | 181 | protective net |
| 12 | mounting member | 182 | a filter net |
| 5 | first connection member | 183 | air inlet grille |
| 6 | second connection member | 19 | sunken platform |
| 61 | mounting hole | 20 | matching member |
| 7 | air inlet hole | 21 | limitation member |
| 8 | air outlet hole | 211 | limitation groove |
| 121 | mounting panel | 22 | buckle groove |
| 122 | first partition | 23 | buckle holder |
| 9 | first heat-insulation | 24 | main body of air |
| | member | | conditioner |
| 13 | second partition | 25 | mounting channel |

The realization, functional features and advantages of the present application will be further described in conjunction with the embodiments and with reference to the accompanying drawings.

### DETAILED DESCRIPTION OF THE EMBODIMENTS

The following will clearly and completely describe the technical solutions in the embodiments of the present application with reference to the accompanying drawings in the embodiments of the present application. Obviously, the described embodiments are only part of the embodiments of the present application, not all of them. Based on the embodiments in the present application, all other embodiments obtained by those skilled in the art without creative efforts fall within the protection scope of the present application.

It should be noted that if there is a directional indication (such as up, down, left, right, front, back . . . ) in the embodiment of the present application, the directional indication is only configured to explain the relationship between the assembly in a certain posture. If the specific posture changes, the directional indication will also change accordingly.

In addition, if there are descriptions involving “first,” “second,” etc. in the embodiments of the present application, the descriptions of “first,” “second,” etc. are only for descriptive purposes, and cannot be understood as indicating or implying their relative importance or implicitly indicating the number of indicated technical features. Thus, the features defined as “first” and “second” may explicitly or implicitly include at least one of these features. In addition, if “and/of” appears throughout the text, its meaning includes three parallel plans, taking “A and/or B” as an example, including plan A, or plan B, or A and B is a solution that is satisfied at the same time. In addition, the technical solutions of the various embodiments can be combined with each other, but it must be based on the realization of those skilled in the art. When the combination of technical solutions is contradictory or cannot be realized, it should be considered that the combination of technical solutions does not exist, nor within the protection scope required by the present application.

After the roof-mounted motorhome air conditioner is mounted at the roof and supplies air to the interior, it must be adapted to the indoor air outlet and air supply terminals of the whole machine to achieve excellent indoor mounting aesthetics and air supply comfort goals. In the related art, the air outlet panel of the air conditioner involves a cross-inlet and outlet design. The air outlet and air inlet of the air conditioner are located on the side of the air outlet panel. The large deflection of the air outlet path will cause large resistance to air flow and large air supply loss.

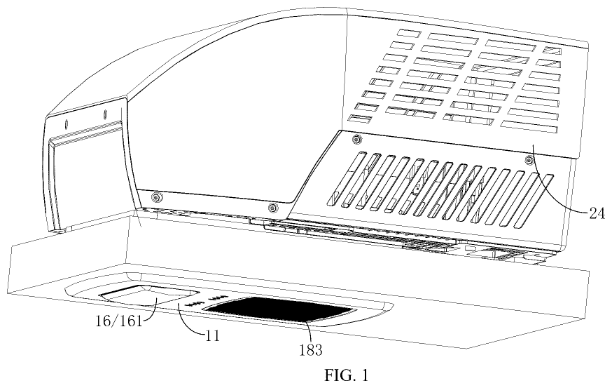

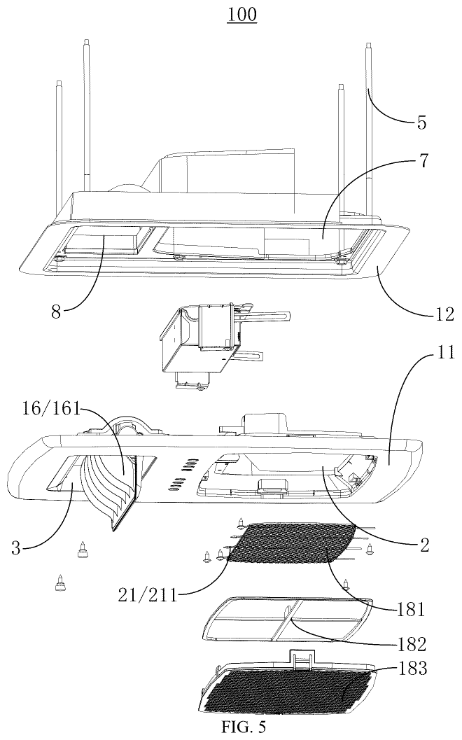

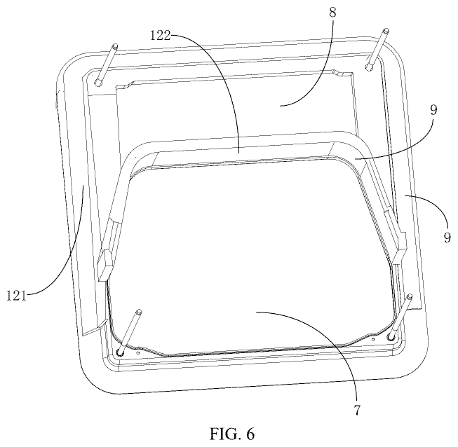

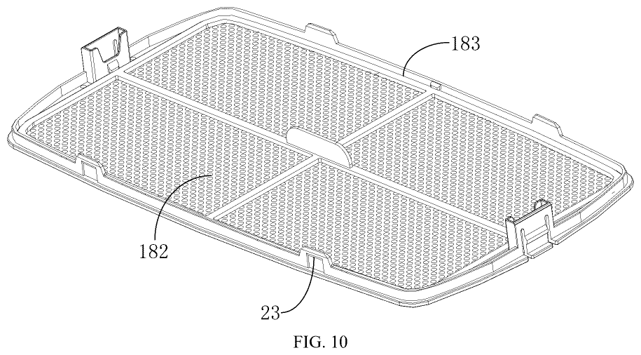

In view of this, the present application provides an air outlet assembly of an air conditioner, and FIGS. 1 to 12 are an embodiment of the present application.

Please refer to FIGS. 1, 4, and 5, the air outlet assembly 100 of the air conditioner can be used on an air conditioner of a vehicle, and includes a mounting member 12, an air outlet panel 11, an air inlet channel and an air outlet channel. The mounting member 12 is provided with a first connection member 5, and the first connection member 5 is configured to connect to the vehicle; the air outlet panel 11 is located below the mounting member 12, and a second connection member 6 is provided; the second connection member 6 is connected to the mounting member 12; the air inlet channel connects the mounting member 12 and the air outlet panel 11, and an air inlet 2 is formed at the air outlet panel 11; the air outlet channel is spaced apart from the air inlet channel in the front-rear direction of the air outlet assembly 100, and connects the mounting member 12 and the air outlet panel 11; an air outlet 3 is formed at the air outlet panel 11.

In the technical solution of the present application, the mounting member 12 and the air outlet panel 11 are assembled on the vehicle to form the air inlet channel and the air outlet channel; the air inlet channel and the air outlet channel are connected to the indoor environment of the vehicle through the air inlet 2 and the air outlet 3 respectively. Since the air inlet 2 and the air outlet 3 are both formed at the air outlet panel 11, the problem of large air path turns of the air inlet duct and the air outlet duct causing resistance to air flow and resulting in large air supply losses is largely avoided.

There is no limitation on the specific type of vehicle to which the air outlet assembly 100 of the air conditioner is applied, and the vehicle may be a passenger vehicle, a truck or a motorhome.

In addition, in the present application, the air outlet panel 11 is provided to be disassembled and assembled on the mounting member 12 so as to achieve the fixation of the air outlet panel 11 in the mounting channel 25, specifically as follows: the first connection member 5 is provided at the mounting member 12, and the mounting member 12 is fixed to the vehicle through the first connection member 5, so that the mounting member 12 can provide a mounting position relative to the air outlet panel 11. When the air outlet panel 11 is mounted, the operator tightens the connection between the air outlet panel 11 and the mounting member 12 through the second connection member 6 to complete the assembly of the mounting member 12 and the air outlet panel 11 as a whole on the vehicle.

It is understandable that the mounting member 12 is connected to the vehicle via the first connection member 5, and the specific connection form is not limited; it can be directly fixed to the mounting wall of the vehicle, or fixedly connected to the main body of the air conditioner 24 located outside the vehicle, or fixed simultaneously to the mounting wall of the vehicle and the main body of the air conditioner 24. In an embodiment of the present application, the mounting member 12 is fixedly connected to the main body of the air conditioner 24 located outside the vehicle via the first connection member 5.

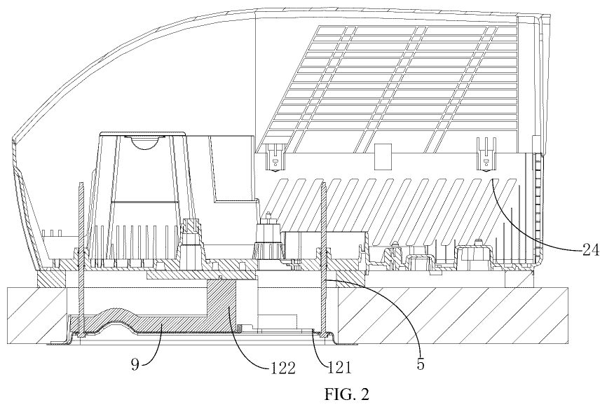

In an embodiment, there is no restriction on the assembly form between the mounting member 12 and the main body of the air conditioner 24, which may be welding, clamping or connection by bolts; please refer to FIG. 2, in an embodiment of the present application, the first connection member 5 includes a screw provided at the mounting member 12; that is, the first connection member 5 is mounted at the main body of the air conditioner 24 by the bolt, and the specific mounting method is as follows: a mounting plane is formed at the side of the main body of the air conditioner 24 contacting the vehicle, and a nut is embedded in the mounting plane; the screw is screwed into the nut to complete the connection and mounting between the mounting member 12 and the main body of the air conditioner 24.

Similarly, the assembly form between the air outlet panel 11 and the mounting member 12 is not limited, and can be welding, clamping or bolted connection; please refer to FIGS. 2, 5 and 8, in an embodiment of the present application, the second connection member 6 includes a mounting hole 61 opened at the air outlet panel 11. That is, in this embodiment, the mounting hole 61 is penetrated by a fastening bolt to complete the fastening connection between the air outlet panel 11 and the mounting member 12.

In the assembly scheme between the mounting member 12 and the main body of the air conditioner 24 described above, and the assembly scheme between the air outlet panel 11 and the mounting member 12, it can be an assembly scheme having either a scheme in which the mounting member 12 includes the screw or a scheme in which the second connecting member includes the mounting hole 61, or it can be an assembly scheme having both of the above-mentioned assembly schemes.

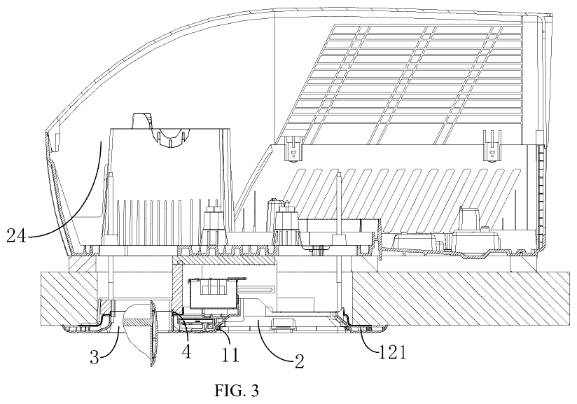

Please refer to FIG. 3, a limitation member 4 is provided at the air outlet panel 11, and the limitation member 4 is configured to limit the air outlet panel 11 in the direction away from the main body of the air conditioner 24. By providing the limitation member 4, the air outlet panel 11 can be limited from falling in the direction away from the main body of the air conditioner 24 when the air outlet panel 11 is mounted, so that the operator can connect the air outlet panel 11 and the mounting member 12 through the second connection member 6. The mounting position of the air outlet panel 11 is described with the top position of the vehicle in the height direction as the mounting position, and the direction from the top to the bottom of the vehicle connection is regarded as the up-down direction. When the air outlet panel 11 is mounted upwardly toward the mounting member 12, the air outlet panel 11 can be limited to the position to be mounted by the limitation member 4, and the air outlet panel 11 is firmly mounted by the second connection member 6 to improve the convenience of mounting the air outlet panel 11.

It should be noted that the above technical solution is not limited to the situation where the air outlet panel 11 is set on the top of the vehicle. When the air outlet panel 11 is mounted at the side of the vehicle or other positions where it may fall, the limitation member 4 can still play the same functional role.

In addition, in the above embodiment, the specific structure of the limitation member 4 is not limited, and can be a fastener, a magnetic member, or an adhesive member. Any structure that can realize the rapid fixing and limiting of the air outlet panel 11 to the mounting member 12 can be used as an embodiment of the specific structure of the limitation member 4 described in the present application. In an embodiment of the present application, the limitation member 4 includes a fastener, which is fastened to the mounting member 12 to complete the pre-mounting between the air outlet panel 11 and the mounting member 12, and facilitate the operator to perform subsequent fastening and mounting operations.

It can be understood that the fastener can be fastened at any position on the mounting member 12, and similarly, a fastening groove or a corresponding matching member corresponding to the fastener can be provided at the mounting member 12.

Please refer to FIGS. 3 to 5, the mounting member 12 includes a mounting panel 121, and the mounting panel 121 is connected to the second connection member 6 of the air outlet panel 11; the air inlet channel includes an air inlet hole 7 correspondingly formed at the mounting panel 121 and docked with the air inlet 2, and the air outlet channel correspondingly includes an air outlet hole 8 formed at the mounting panel 121 and docked with the air outlet 3. That is, in this embodiment, the air inlet hole 7 constitutes a part of the air inlet channel, and the air outlet hole 8 constitutes a part of the air outlet duct. When the air outlet panel 11 is mounted, the air inlet 2 docks with the air inlet hole 7, and the air outlet 3 docks with the air outlet hole 8. Such a design makes it convenient for the operator to compare and adjust the mounting direction of the air outlet panel 11 when mounting the air outlet panel 11 on the mounting panel 121.

Similarly, the embodiment in which the limitation member 4 described above includes a fastener is applied to the technical solution in which the air inlet hole 7 and the air outlet hole 8 are provided here, that is, the fasteners provided at the air outlet panel 11 include a plurality of fasteners, which are respectively fastened to the peripheries of the air inlet hole 7 and the air outlet hole 8. With such a design, there is no need to provide a fastening groove or matching member corresponding to the fastener on the mounting panel 121, and the molding difficulty of the mounting panel 121 is lower.

Please refer to FIGS. 2, 3 and 6, the mounting member 12 further includes a first partition 122, which is provided at a side of the mounting panel 121 away from the air outlet panel 11 and between the air inlet hole 7 and the air outlet hole 8, for separating the air inlet channel and the air outlet channel. In this embodiment, when the mounting panel 121 is mounted at a vehicle, the first partition can separate the space between the main body of the air conditioner 24 and the mounting panel 121 into two parts to form a part of the air inlet channel and the air outlet channel, and the two parts separated by the partition are connected to the air inlet end and the air outlet end of the main body of the air conditioner 24 respectively, so that the air inlet and air outlet of the main body of the air conditioner 24 do not interfere with each other.

In an embodiment, the mounting panel 121 is provided with a first heat-insulation member 9 on the side away from the air outlet panel 11 and around the air outlet hole 8; the first heat-insulation member 9 is located between the air inlet hole 7 and the air outlet hole 8, constituting the first partition 122. That is, the provision of the first heat-insulation member 9 can prevent air leakage at the air outlet hole 8 from affecting the air outlet effect, and can also avoid the phenomenon of condensation caused by the intersection of hot air flows; the first heat-insulation member 9 is located between the air inlet hole 7 and the air outlet hole 8, constituting the first partition 122, that is, the first heat-insulation member 9 can not only separate the air inlet channel from the air outlet channel, but also further limit the intersection of hot air flows between the air inlet channel and the air outlet channel.

The specific material of the first heat-insulation member 9 is not limited, and can be foam or sponge. In an embodiment of the present application, the first heat-insulation member 9 is made of foam.

Similarly, the first heat-insulation member 9 may also be provided at the peripheral side of the mounting panel 121. The first heat-insulation member 9 provided at the peripheral side of the mounting panel 121 can seal the gap between the mounting panel 121 and the vehicle when the mounting panel 121 is mounted in the mounting channel 25, and can further avoid the problem of air leakage around the air outlet hole 8.

The specific material of the first heat-insulation member 9 disposed around the mounting panel 121 is not limited, and can be foam or sponge. In an embodiment of the present application, the first heat-insulation member 9 disposed around the air outlet panel 11 is made of sponge.

In addition, since the air inlet hole 7 is connected to the air inlet 2, and the air outlet hole 8 is connected to the air outlet 3 when the air outlet panel 11 is mounted to the mounting panel 121, in order to avoid the problem of airflow intersection between the air inlet channel and the air outlet channel caused by the mounting gap between the air outlet panel 11 and the mounting panel 121, in an embodiment of the present application, a second partition 13 is further provided between the mounting panel 121 and the air outlet panel 11; the second partition 13 is provided between the air outlet 3 and the air inlet 2, so as to limit the intersection of the outlet airflow between the air outlet hole 8 and the air outlet 3, and the inlet airflow between the air inlet hole 7 and the air inlet 2. The second partition 13 may be provided at a side of the air outlet panel 11 close to the mounting panel 121, or on a side of the mounting panel 121 close to the mounting panel 121, or on a side of the mounting panel 121 close to the air outlet panel 11, or part of the second partition 13 may be provided at both the air outlet panel 11 and the mounting panel 121, and no limitation is made here.

In an embodiment, the air outlet panel 11 is provided with a second heat-insulation member 14 on one side close to the mounting panel 121 and around the air outlet 3. The second heat-insulation member 14 is located between the air inlet 2 and the air outlet 3, constituting the second partition 13. That is, the second heat-insulation member 14 is provided at the air outlet panel 11. The arrangement of the air outlet panel 11 can prevent air leakage at the air outlet 3 from affecting the air outlet effect, and can also avoid the phenomenon of condensation caused by the intersection of hot air flows. The second heat-insulation member 14 is located between the air inlet 2 and the air outlet 3, constituting the second partition 13. The second heat-insulation member 14 can not only separate the air inlet channel from the air outlet channel, but also further limit the intersection of hot air flows between the air inlet channel and the air outlet channel.

The specific material of the second heat-insulation member 14 is not limited, and can be foam or sponge. In an embodiment of the present application, the second heat-insulation member 14 is made of foam.

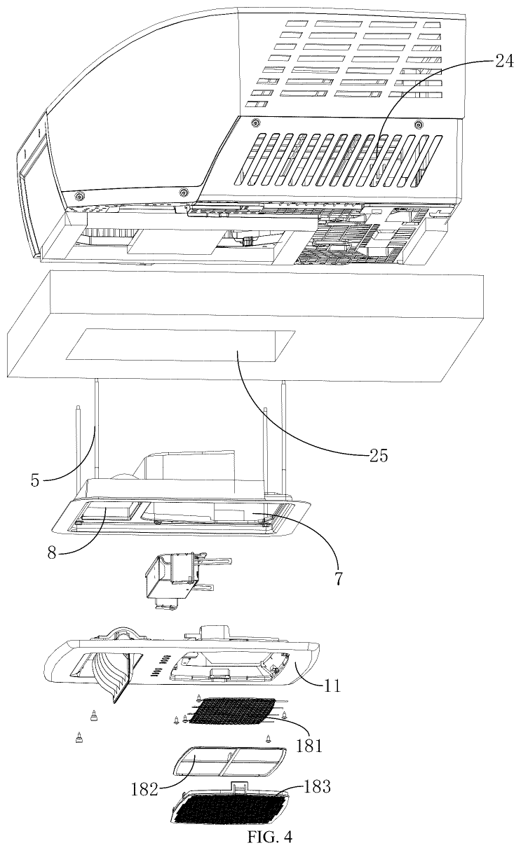

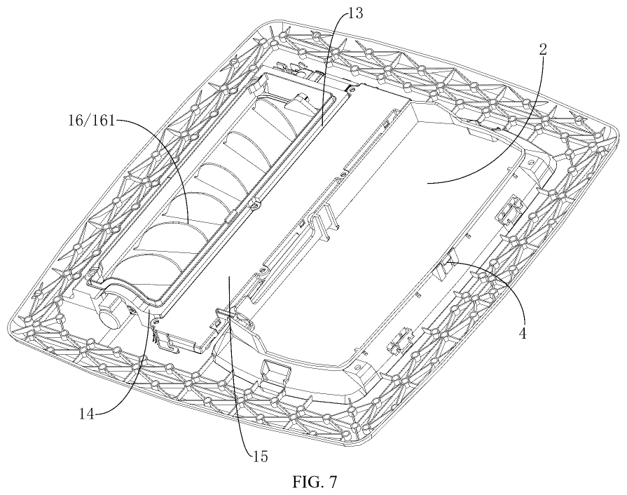

Please refer to FIGS. 4 and 7, in order to facilitate the mounting of various electrical parts in the air outlet assembly 100 of the air conditioner, in an embodiment of the present application, a mounting area 15 for mounting electronic devices is formed between the mounting panel 121 and the air outlet panel 11. By providing the mounting area 15 between the mounting panel 121 and the air outlet panel 11, the air outlet panel 11 can be designed to be detachable, which is convenient for repairing and replacing electronic devices. At the same time, between the mounting of the mounting panel 121 and the air outlet panel 11, the electronic device can be pre-fixed on the air outlet panel 11 or the part of the mounting panel 121 corresponding to the mounting area 15 to facilitate the mounting of the electronic device. The electronic device can include multiple devices, such as display screen components, WiFi components, etc. Similarly, the mounting area 15 can also be mounted with other mechanical parts and components, such as junction box structures, etc.; the corresponding mounting form of the electronic device or mechanical parts and components structure is not limited, and can be snap-on, screw-on or glue-on.

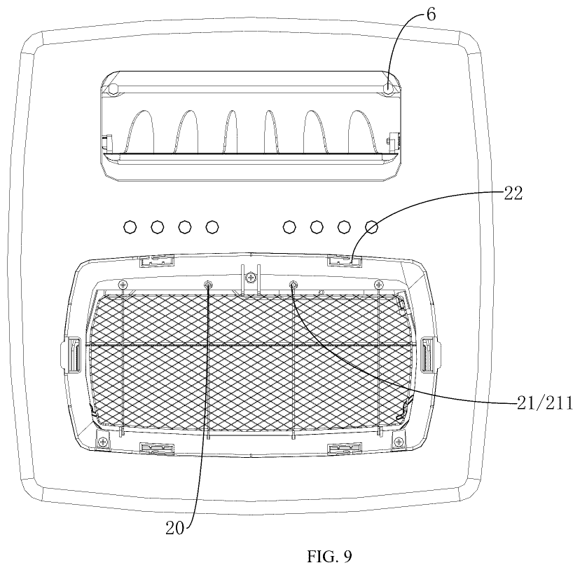

Please refer to FIGS. 7 and 9, an air guide plate structure 16 is also provided at the position of the air outlet 3. The air guide plate structure 16 includes an air guide plate 161. The air guide plate 161 is movably provided at the air outlet 3. The air guide plate 161 has a first position covering the air outlet 3 in its movable stroke. When the air guide plate 161 is located at the first position, at least part of the air guide plate 161 covers the peripheral position of the air outlet 3. The second connection member 6 is correspondingly provided at the air outlet panel 11 in an area that can be covered by the air guide plate 161.

Among them, when the main body of the air conditioner 24 is not in working state, the air guide plate 161 covers the air outlet 3. At this time, on the side of the air outlet panel 11 away from the mounting panel 121, part of the air guide plate 161 will cover the peripheral position of the air outlet 3, and the second connection member 6 is provided in this area covered by the air guide plate 161. When the air conditioner is not in working state, the second connection member 6 will not be exposed to the user, so as to improve the overall aesthetics of the air outlet assembly 100 of the air conditioner. Taking the second connection member 6 including the mounting hole 61 in the above technical solution as an example, the air guide plate 161 will cover the mounting hole 61, so that the mounting hole 61 is not exposed to the user.

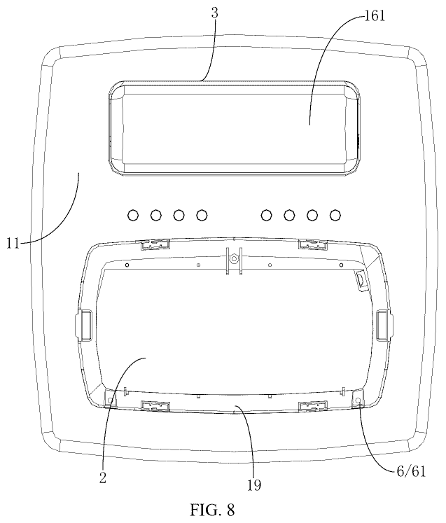

Please refer to FIGS. 8 to 10, the air outlet panel 11 is provided with a sunken platform 19 on the side away from the mounting member 12 and around the periphery of the air inlet 2. The sunken platform 19 is provided with a protective net 181, a filter net 182 and an air inlet grille 183 which are sequentially overlapped and provided in a direction away from the air outlet panel 11. The second connection member 6 is correspondingly provided at the sunken platform 19. The air inlet grille 183 covers the sunken platform 19. By providing the protective net 181, the filter net 182 and the air inlet grille 183, a multi-layer protection function is achieved. When the air inlet grille 183 is mounted, the second connection member 6 located on the sunken platform 19 is covered, and the second connection member 6 will not be exposed to the user, so as to improve the overall aesthetics of the air outlet assembly 100 of the air conditioner. Taking the second connection member 6 including the mounting hole 61 in the above technical solution as an example, the grille will cover the mounting hole 61, so that the mounting hole 61 is not exposed to the user.

In combination with the embodiment in which the second connection member 6 is provided at the sunken platform 19, and the embodiment in which the second connection member 6 is provided at the periphery of the air outlet 3, the second connection member 6 is provided at the positions corresponding to the air outlet 3 and the air inlet 2 to connect the air outlet panel 11 and the mounting panel 121, thereby dispersing the fixed connection points of the air outlet panel 11, so that the air outlet panel 11 has good fastening force characteristics, and a strong and reliable connection and fixation is achieved.

In an embodiment, a matching member 20 is provided at one of the sunken platform 19 and the protective net 181, and a limitation member 21 is provided at the other of the sunken platform 19 and the protective net 181. A limitation groove 211 is formed at the limitation member 21, and the limitation groove 211 is configured for the matching member 20 to be embedded. The matching member 20 may be provided at the sunken platform 19, and the limitation member 21 is provided at the protective net 181; or the limitation member 21 is provided at the sunken platform 19, and the matching member 20 is provided at the protective net 181. In an embodiment of the present application, the limitation member 21 is provided at the protective net 181, and the matching member 20 is provided at the sunken platform 19. Through the matching mounting between the limitation groove 211 and the matching member 20, the protective net 181 can be initially fixed on the sunken platform 19, so that the operator can conveniently fasten and mount the protective net 181.

In an embodiment, the filter net 182 is detachably mounted at the side of the air inlet grille 183 close to the air outlet panel 11; one of the air inlet grille 183 and the sunken platform 19 is formed with a buckle groove 22, and the other is provided with a buckle holder 23. The buckle holder 23 is buckled in the buckle groove 22. The filter net 182 is detachably mounted at the air inlet grille 183, so that the air inlet grille 183 and the filter net 182 can be disassembled and assembled at the same time, and the form in which the filter net 182 is mounted at the air inlet grille 183 is not limited, and can be snap-fitted or screw-fitted; in addition, the fixed connection form between the air inlet grille 183 and the sunken platform 19 is not limited, and can be snap-fitted or screw-fitted. In an embodiment of the present application, the air inlet grille 183 is snap-fitted with the sunken platform 19 to facilitate disassembly and assembly, and the air inlet grille 183 can be quickly mounted through the mutual cooperation between the buckle groove 22 and the buckle holder 23.

In addition, the air inlet grille 183 and the filter net 182 are provided to be quickly disassembled and assembled at the air inlet 22, and the protective net 181 is fastened at the air inlet 2. After the air inlet grille 183 is removed, the protective net 181 can still play a protective role. On the one hand, it can prevent human tissue from extending into the air inlet channel and being injured. On the other hand, it can prevent debris from entering the air inlet channel and causing damage to the main body of the air conditioner 24.

Please refer to FIGS. 7 and 8, the cross-sectional area of the air inlet 2 is larger than the cross-sectional area of the air outlet 3. By setting the cross-sectional area of the air inlet 2 to be larger than the cross-sectional area of the air outlet 3, the air intake volume of the main body of the air conditioner 24 is increased, and the air outlet volume is reduced, thereby improving the user experience.

The present application also provides the main body of the air conditioner 24, which can be mounted at the top of a vehicle, including a body. An air outlet assembly 100 as described above is connected below the body, and the air outlet assembly 100 includes the air outlet assembly 100 as described above. Since the present main body of the air conditioner 24 adopts all the technical solutions of all the above embodiments, it at least has the beneficial effects brought by the technical solutions of the above embodiments, which will not be described one by one here. Among them, when the main body of the air conditioner 24 is set on the vehicle, the surrounding sides of the air inlet end and the air outlet end are also provided with sealing members to seal the gap between the main body of the air conditioner 24 and the vehicle.

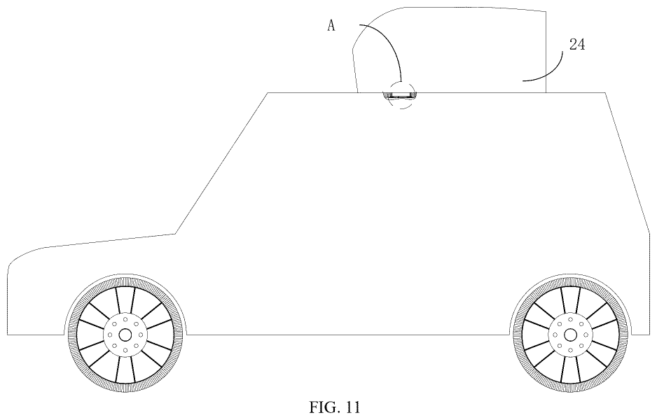

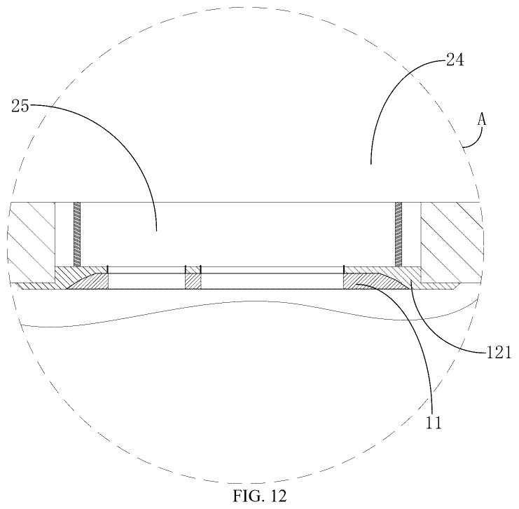

Referring to FIGS. 11 and 12, the present application also provides a vehicle, including a vehicle body and a main body of the air conditioner 24, and the vehicle body being provided with a mounting channel 25; the main body of the air conditioner 24 includes the main body of the air conditioner 24 as described above; since the present vehicle adopts all the technical solutions of all the above embodiments, it at least has the beneficial effects brought by the technical solutions of the above embodiments, which will not be described one by one here. The specific type of the vehicle is not limited, and it can be a passenger vehicle, a truck, or a motorhome.

In an embodiment, the air outlet panel 11 is correspondingly provided in the mounting channel 25. That is, when the air outlet panel 11 is provided in the mounting channel 25, it will not protrude from the mounting channel 25, so that the interior space of the vehicle body will look more beautiful, and will not cause an abrupt appearance, bring a sense of oppression to the interior space of the vehicle body with a small space, resulting in a poor user experience.

The above are only some embodiments of the present application, and do not limit the patent scope of the present application. Under the inventive concept of the present application, the equivalent structural transformations made by using the description of the present application and the contents of the accompanying drawings, or directly/indirectly used in other relevant technical fields, are all included in the protection scope of the present application.

1.-14. (canceled)

15. An air outlet assembly comprising:
a mounting member provided with a first connection member configured to be connected to a vehicle;
an air outlet panel located below the mounting member and provided with a second connection member, the second connection member being connected to the mounting member;
an air inlet channel communicating the mounting member with the air outlet panel, one end of the air inlet channel having an air inlet formed at the air outlet panel; and
an air outlet channel spaced apart from the air inlet channel in a front-rear direction of the air outlet assembly, the air outlet channel communicating the mounting member with the air outlet panel, and one end of the air outlet channel having an air outlet formed at the air outlet panel.

16. The air outlet assembly according to claim 15, wherein:
the mounting member includes a mounting panel connected to the second connection member of the air outlet panel; and
an air inlet hole is formed at the mounting panel at another end of the air inlet channel, and an air outlet hole is formed at the mounting panel at another end of the air outlet channel.

17. The air outlet assembly according to claim 16, wherein the mounting member further includes a partition provided at a side of the mounting panel away from the air outlet panel and between the air inlet hole and the air outlet hole, for separating the air inlet channel and the air outlet channel.

18. The air outlet assembly according to claim 17, wherein a mounting area for mounting an electronic device is formed between the mounting panel and the air outlet panel.

19. The air outlet assembly according to claim 16, wherein a partition is provided between the mounting panel and the air outlet panel, and the partition is provided between the air outlet and the air inlet to limit an intersection of an outlet airflow between the air outlet hole and the air outlet and an inlet airflow between the air inlet hole and the air inlet.

20. The air outlet assembly according to claim 19, wherein a mounting area for mounting an electronic device is formed between the mounting panel and the air outlet panel.

21. The air outlet assembly according to claim 15, wherein:
the air outlet is further provided with an air guide plate structure including an air guide plate, and the air guide plate is movably provided at the air outlet;
the air guide plate is configured such that when the air guide plate is located at a covering position, at least a portion of the air guide plate covers a peripheral part of the air outlet; and
the second connection member is provided corresponding to an area on the air outlet panel capable of being covered by the air guide plate.

22. The air outlet assembly according to claim 15, wherein:
the air outlet panel is provided with a sunken platform on a side away from the mounting member and around a periphery of the air inlet;
the sunken platform is provided with a protective net, a filter net, and an air inlet grille stacked in sequence in a direction away from the air outlet panel;
the second connection member is provided at the sunken platform; and
the air inlet grille is provided to cover the sunken platform.

23. The air outlet assembly according to claim 22, wherein:
a matching member is provided at one of the sunken platform and the protective net, and a limitation member is provided at another one of the sunken platform and the protective net; and
a limitation groove is formed at the limitation member, and the limitation groove is configured for the matching member to be embedded.

24. The air outlet assembly according to claim 22, wherein:
the filter net is detachably mounted at a side of the air inlet grille close to the air outlet panel; and
a buckle groove is formed at one of the air inlet grille and the sunken platform, and a buckle holder is provided at another one of the air inlet grille and the sunken platform, being configured to be buckled in the buckle groove.

25. The air outlet assembly according to claim 15, wherein a limitation member is provided at the air outlet panel, and the limitation member is configured to limit the air outlet panel in a direction away from a main body of the air conditioner.

26. The air outlet assembly according to claim 15, wherein the first connection member includes a screw provided at the mounting member.

27. The air outlet assembly according to claim 15, wherein the second connection member includes a mounting hole opened at the air outlet panel.

28. A main body of an air conditioner, comprising:
a body; and
an air outlet assembly connected below the body, the air outlet assembly including:
a mounting member provided with a first connection member configured to be connected to a vehicle;
an air outlet panel located below the mounting member and provided with a second connection member, the second connection member being connected to the mounting member;
an air inlet channel communicating the mounting member with the air outlet panel, one end of the air inlet channel having an air inlet formed at the air outlet panel; and
an air outlet channel spaced apart from the air inlet channel in a front-rear direction of the air outlet assembly, the air outlet channel communicating the mounting member with the air outlet panel, and one end of the air outlet channel having an air outlet formed at the air outlet panel.

29. The main body according to claim 28, wherein:
the mounting member includes a mounting panel connected to the second connection member of the air outlet panel; and
an air inlet hole is formed at the mounting panel at another end of the air inlet channel, and an air outlet hole is formed at the mounting panel at another end of the air outlet channel.

30. The main body according to claim 29, wherein the mounting member further includes a partition provided at a side of the mounting panel away from the air outlet panel and between the air inlet hole and the air outlet hole, for separating the air inlet channel and the air outlet channel.

31. The main body according to claim 30, wherein a mounting area for mounting an electronic device is formed between the mounting panel and the air outlet panel.

32. The main body according to claim 29, wherein a partition is provided between the mounting panel and the air outlet panel, and the partition is provided between the air outlet and the air inlet to limit an intersection of an outlet airflow between the air outlet hole and the air outlet and an inlet airflow between the air inlet hole and the air inlet.

33. The main body according to claim 32, wherein a mounting area for mounting an electronic device is formed between the mounting panel and the air outlet panel.

34. A vehicle comprising:
a vehicle body, a mounting channel being formed at the vehicle body; and
an air conditioner including a main body, the main body including:
a body at least partially connected to the mounting channel; and
an air outlet assembly connected below the body, the air outlet assembly including:
a mounting member provided with a first connection member configured to be connected to a vehicle;
an air outlet panel located below the mounting member and provided with a second connection member, the second connection member being connected to the mounting member;
an air inlet channel communicating the mounting member with the air outlet panel, one end of the air inlet channel having an air inlet formed at the air outlet panel; and
an air outlet channel spaced apart from the air inlet channel in a front-rear direction of the air outlet assembly, the air outlet channel communicating the mounting member with the air outlet panel, and one end of the air outlet channel having an air outlet formed at the air outlet panel.
